(19) United States
(12) Patent Application Publication
(10) Pub. No.: US 2016/0335201 A1
(43) Pub. Date: Nov. 17, 2016

(54) DATA AND INSTRUCTION SET ENCRYPTION

(71) Applicant: HEWLETT PACKARD ENTERPRISE DEVELOPMENT LP, Houston, TX (US)

(72) Inventor: Perry V. Lea, Eagle, ID (US)

(21) Appl. No.: 15/111,745

(22) PCT Filed: Jan. 28, 2014
(86) PCT No.: PCT/US2014/013360

§ 371 Date: Jul. 14, 2016

(51) Int. Cl. G06F 12/14; G06F 12/1009; H04L 9/08

(52) U.S. Cl. CPC G06F 12/1408; H04L 9/0861; G06F 12/1009; G06F 2212/1052; G06F 2212/402

(57) ABSTRACT

According to an example, data and instruction set encryption may include generating keys to encrypt data and instructions. The instructions may be executable by a CPU. The keys may be mapped to memory ranges of a PM including a flat address space. The flat address space of the PM may be partitioned according to the memory ranges. The keys and the memory ranges mapped to the keys may be stored in a keymap array. The data and the instructions may be encrypted based on the keys.

### BACKGROUND

Computing systems typically include computing elements such as a central processing unit (CPU), non-persistent random-access memory (RAM) such as double data rate synchronous dynamic RAM (DDR SDRAM), and persistent memory (PM) that is implemented using non-volatile memory (NVM) technologies. Examples of PMs include phase change memory (PCM) and memristor based memory. With respect to data stored in memory, encryption is the process of encoding the data in such a way that unauthorized parties may not read the data, but authorized parties may read the data.

### BRIEF DESCRIPTION OF DRAWINGS

Features of the present disclosure are illustrated by way of example and not limited in the following figure(s), in which like numerals indicate like elements, in which:

FIG. 1 illustrates an architecture of a data and instruction set encryption apparatus, according to an example of the present disclosure;

FIG. 2 illustrates a keymap array for the data and instruction set encryption apparatus, according to an example of the present disclosure;

FIG. 3 illustrates decryption of data for the data and instruction set encryption apparatus, according to an example of the present disclosure;

FIG. 4 illustrates a memristor array based implementation of the data and instruction set encryption apparatus, according to an example of the present disclosure;

FIG. 5 illustrates a method for data and instruction set encryption, according to an example of the present disclosure;

FIG. 6 illustrates further details of the method for data and instruction set encryption, according to an example of the present disclosure; and

FIG. 7 illustrates a computer system, according to an example of the present disclosure.

### DETAILED DESCRIPTION

For simplicity and illustrative purposes, the present disclosure is described by referring mainly to examples. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure.

Throughout the present disclosure, the terms “a” and “an” are intended to denote at least one of a particular element. As used herein, the term “includes” means includes but not limited to, the term “including” means including but not limited to. The term “based on” means based at least in part on.

In computing systems, a memory hierarchy that includes non-persistent RAM such as DDR SDRAM, and further includes PM, execution of CPU instructions typically transpires out of the DDR SDRAM. For such computing systems, data placed in the PM may be encrypted. In order for the CPU to use the data, the data needs to be decrypted when placed in the non-persistent RAM. Since the data placed in the non-persistent RAM is not encrypted, computing systems including such a memory hierarchy may not be considered fully secure. An unauthorized third party may compromise such computing systems by accessing and altering the non-persistent RAM.

According to examples, a data and instruction set encryption apparatus and a method for data and instruction set encryption are disclosed herein. The apparatus and method disclosed herein may include a storage control module to implement a memory hierarchy including a CPU and a PM. According to an example disclosed herein, the PM may include a memristor array or a PCM. The memory hierarchy including the CPU and the PM may provide a flat memory hierarchy where the entire memory space of the PM may be linear, sequential, and contiguous from address zero to a maximum number of bytes—1. The storage control module and the flat PM address space may provide for data and instructions (i.e., executable CPU instructions) to be encrypted and decrypted.

For the apparatus and method disclosed herein, the PM may subsume the operations of dynamic memory (i.e., non-persistent RAM) and NVM. For the apparatus and method disclosed herein, the logical memory space of the PM may be encrypted. Further, CPU instructions may also be encrypted, and thus randomized as disclosed herein. The memory space encryption of the CPU instructions and the data stored in the PM may protect, for example, against intrusion based attacks. For example, the memory space encryption of the CPU instructions and the data stored in the PM may protect, for example, against heap attacks and buffer overflows based on the active control and modification of the language used by the CPU (i.e., the instructions used by the CPU). For example, for the apparatus and method disclosed herein, based on instruction set encryption, dynamically linked libraries (DLLs), statically linked libraries (SLLs), and executable code may be encrypted, without impact on the CPU architecture. A DLL may be a shared library of executable machine readable instructions used between different executable processes. A SLL may be is a set of routines, external functions, and/or variables which are resolved in a caller at compile-time, and copied into a target application by a compiler, linker, or binder, producing an object file and a stand-alone executable. For the apparatus and method disclosed herein, the storage control module may operate in conjunction with an encryption and decryption module to actively and dynamically change encryption keys (i.e., re-encrypt data and instructions) that are stored in a keymap array, and are used for the memory space encryption of the CPU instructions and the data stored in the PM. The apparatus and method disclosed herein may also provide support for managed code since data is encrypted.

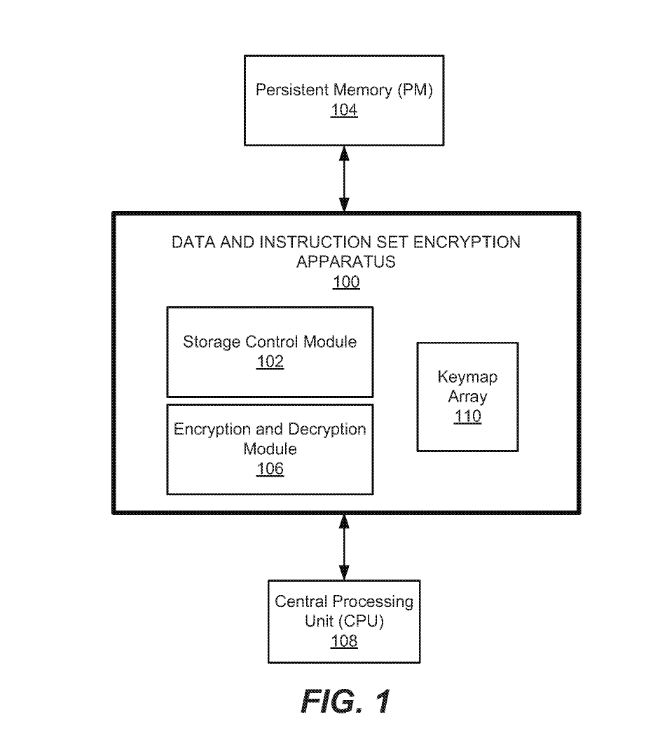

FIG. 1 illustrates an architecture of a data and instruction set encryption apparatus (hereinafter also referred to as “apparatus 100”), according to an example of the present disclosure. Referring to FIG. 1, the apparatus 100 is depicted as including a storage control module 102 to communicate with and control a PM 104. The PM 104 may be a memristor array, a PCM, or another type of memory that includes functionality similar to that of a memristor array or a PCM. The PM 104 may include a flat address space. The flat address space of the PM 104 may be partitioned according to memory ranges.

The apparatus 100 may further include an encryption and decryption module 106 that may be an advanced encryption standard (AES)-256 encryption block, an XOR mechanism, etc., which may be based on a private key. The encryption and decryption module 106 may generate keys to encrypt data and instructions that are executable by a CPU 108. The keys may be generated via a pseudo-random process. For example, the pseudo-random process may be based on time, phase lock loop (PLL) frequency generation, and/or resistance values of memristor cells for a PM 104 implemented as a memristor array. The encryption and decryption module 106 may encrypt and decrypt the data and the instructions based on the keys.

A keymap array 110 may map the keys to the memory ranges of the PM 104. The keymap array 110 may further store the keys and the memory ranges mapped to the keys. The keymap array 110 may be read and written to by the storage control module 102 and the encryption and decryption module 106. The keys of the keymap array 110 may be used to encrypt and decrypt the data and the instructions stored in the PM 104. Pages, files, and/or individual addresses may be mapped and encrypted using independent keys of the keymap array 110. The PM 104 may store the data and the instructions that are used by a CPU 108 according to the key to memory range mapping of the keymap array 110. The keymap array 110 may be stored in a NVM within the data and instruction set encryption apparatus 100 such that in the event of a power loss the information stored in the keymap array 110 may be preserved.

The modules and other elements of the apparatus 100 may be machine readable instructions stored on a non-transitory computer readable medium. In addition, or alternatively, the modules and other elements of the apparatus 100 may be hardware or a combination of machine readable instructions and hardware.

The storage control module 102 may initiate re-encryption of the data and the instructions dynamically. The aspect of dynamic data and instruction re-encryption may provide for randomization of the contents of the PM 104, thus adding further security to the data and instruction set encryption apparatus 100. For example, during idle cycles or at predetermined time intervals, the storage control module 102 may locate areas of the PM 104, and initiate change of the associated keys. For example, during cleanup (e.g., related to least frequently used data) or merging of data, the storage control module 102 may locate areas of the PM 104 and initiate change of the associated keys. These processes may be hidden from a user. For example, the storage control module 102 may initiate re-encryption of data and/or instructions as the data and/or instructions are copied from the old cells of the PM 104 to new cells of the PM 104. During this process, a new associated key may be stored in the keymap array 110.

The dynamic re-encryption of the data and/or executable instructions may add further security to the data and instruction set encryption apparatus 100 with respect to an intrusion based attack since an unauthorized user using a buffer overflow or heap attack may need to understand the operation code language to inject the correct assembly at the correct address. The operation code may represent the portion of a machine language instruction that specifies the operation to be performed. Without the appropriate knowledge of the operation code language, the unauthorized user may be limited to injecting random code into the instruction stream. Further, since the re-encryption is dynamic and may change based on heuristics of the storage control module 102, this may add further security to the data and instruction set encryption apparatus 100 since the keys are subject to change.

The data and instruction set encryption provided by the data and instruction set encryption apparatus 100 may thus add security to a device using the data and instruction set encryption apparatus 100. For example, for a 32 bit architecture, the number of possible guesses to encode an instruction correctly for an attack on a device using the apparatus 100 may be on the order of 2³². If a device using the data and instruction set encryption apparatus 100 uses bit transportation, for a 32 bit architecture, the number of possible guesses to encode an instruction correctly for an attack on a device using the apparatus 100 may be on the order of 32!.

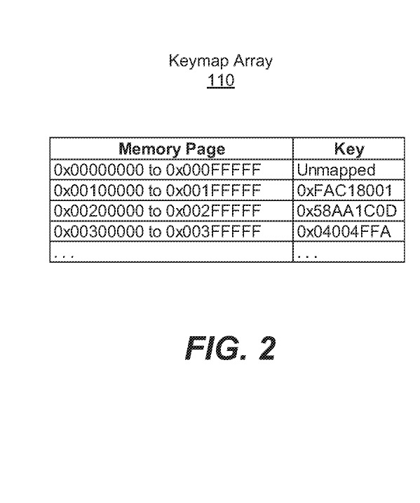

FIG. 2 illustrates a keymap array 110, according to an example of the present disclosure. As illustrated in FIG. 2, the keymap array 110 may be implemented as a lookup-table, and include a memory page row including memory ranges corresponding to a memory page, and a key row including corresponding keys. For example, the keys may represent encryption and decryption keys used by the encryption and decryption module 106 to encrypt or decrypt data and/or instructions associated with the corresponding memory page. The flat addressable memory space of the PM 104 may be encoded within the keymap array 110. When an address is presented to the keymap array 110, the address may be matched to determine which memory page the address resides in. The storage control module 102 may return the associated key, and feed the key directly to the encryption and decryption module 106 to encrypt or decrypt data and/or instructions associated with the corresponding memory page. The process related to key search and retrieval may be pipelined to minimize bandwidth usage.

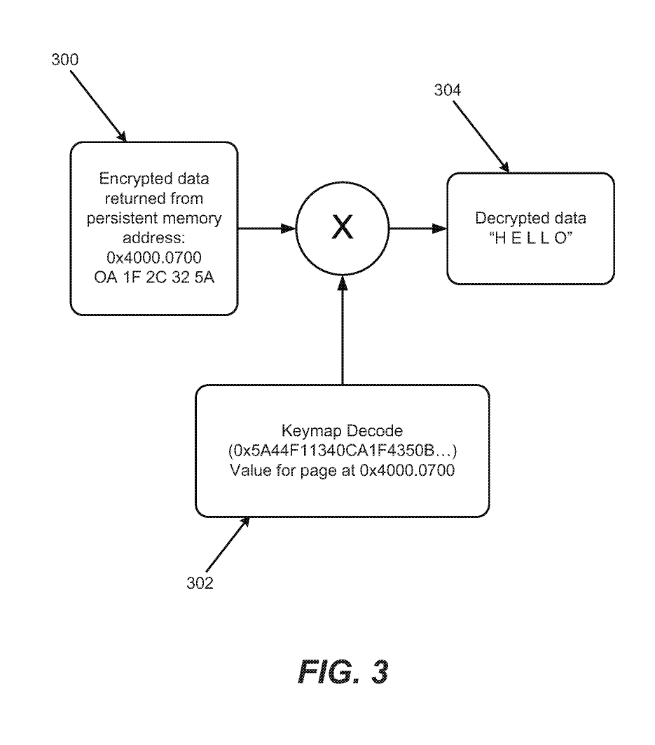

FIG. 3 illustrates decryption of data for the data and instruction set encryption apparatus 100, according to an example of the present disclosure. Following a read from the PM 104, the storage control module 102 may operate in conjunction with the encryption and decryption module 106 to decode the data and/or the instructions. The encryption and decryption module 106 may apply an XOR function to decode the data and/or the instructions with the key ascertained from the keymap array 110. For example, as shown in FIG. 3, encrypted data returned from the PM 104 is shown at 300, and the key ascertained from the keymap array 110 is shown at 302. The decrypted data based on application of the XOR function is shown at 304.

With respect to unmapped or unaccessed memory pages, the storage control module 102 may process unmapped or unaccessed memory pages as follows. Specifically, unmapped or unaccessed memory pages may represent memory pages that may relate to a program, corresponding DLLs of the program, and corresponding EXE machine readable instructions that have not been accessed (e.g., a first time run). For example, as shown in FIG. 2, the memory page 0x00000000 to 0x000FFFFF may be unmapped. In this case, the keymap array 110 may not be populated with a key that represents a decoded value. As a first option, if the keymap array 110 is not populated for a specific area of the memory space of the PM 104, the keymap array 110 may remain unpopulated based on the assumption that the memory page is not to be encrypted. As an alternative option, the storage control module 102 may attempt to encrypt the associated data and/or instructions on the first execution or access of the new memory space. The encryption of the associated data and/or instructions may be performed when new memory ranges of the PM 104 are used (e.g., when downloading and installing a new program). The data and/or instructions may be encrypted by the encryption and decryption module 106, and keymap decode values may be generated as the program installs in the PM 104.

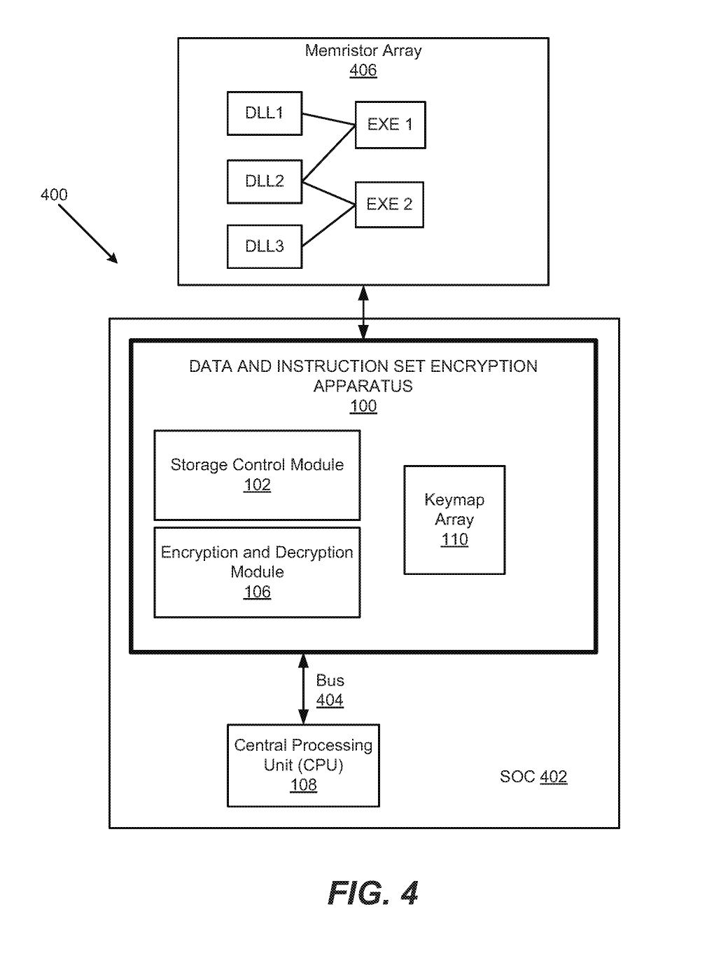

FIG. 4 illustrates a memristor array based implementation of the data and instruction set encryption apparatus 100, according to an example of the present disclosure. The data and instruction set encryption apparatus 100 may be implemented on a system on a chip (SOC) 402 that includes the CPU 108 that is communicatively linked to the data and instruction set encryption apparatus 100 by a bus 404. The SOC 402 may be communicatively linked to a PM, which in the example of FIG. 4 is illustrated as a memristor array 406. In the example of FIG. 4, the memristor array 406 may include DLLs 1-3 that are communicatively linked to executable (EXE) files 1 and 2. The EXE files may include instructions that are performed by the CPU 108, which as disclosed herein, may be encrypted along with the associated DLLs. The storage control module 102 may communicate with and control the memristor array 406.

The data flow for the CPU 108, or another hardware block on the SOC 402 to read data and/or an instruction (i.e., an instruction executable by the CPU 108) may include an initiation of a request to memory (e.g., the memristor array 406). The request to memory may include a read to fetch an instruction or to retrieve data. The request to memory may flow to the apparatus 100 via the bus 404. For example, the request to memory may be presented on the bus 404, and migrate to the storage control module 102 of the apparatus 100. The request to memory may include an address and/or a cache line linked to the address.

With respect to the data flow for the CPU 108, or another hardware block on the SOC 402 to read the data and/or the instruction, following the request to memory, the storage control module 102 may buffer the request to memory within a request queue that is managed by the storage control module 102. Further, the storage control module 102 may control the electrical interface to the memory (e.g., the surface of the memristor array 406). According to an example, the storage control module 102 may use column/row addressing to read data and/or an instruction from the memory.

With respect to the data flow for the CPU 108, or another hardware block on the SOC 402 to read the data and/or the instruction, following the buffering of the request to memory within the request queue, the storage control module 102 may resolve an address associated with the request to memory, and match the address with the keymap array 110 to ascertain an associated key. The storage control module 102 may initiate the request to memory to fetch data and/or an instruction from the memristor array 406. Specifically, the storage control module 102 may pipeline the request to memory from the request queue. As the storage control module 102 receives an address to be decoded, the storage control module 102 may compare the address to the keymap array 110. The keymap array 110 may hold the address ranges (e.g., in memory pages) for the entire memory (e.g., the memristor array 406).

With respect to the data flow for the CPU 108, or another hardware block on the SOC 402 to read the data and/or the instruction, following the address resolution and keymap matching, the storage control module 102 may perform the read of the data and/or the instruction. The read of the data and/or the instruction may be performed simultaneously as the storage control module 102 is referencing the keymap array 110. The access to the keymap array 110 may be presented to analog physical ports on the SOC 402 as column and address pairs. The memory (e.g., the memristor array 406) may return a line width of data (e.g., 32 bytes or 64 bytes) to the storage control module 102.

With respect to the data flow for the CPU 108, or another hardware block on the SOC 402 to read the data and/or the instruction, following the read from the memory, the encryption and decryption module 106 may decode the data and/or the instruction. As disclosed herein with reference to FIG. 3, the encryption and decryption module 106 may apply an XOR function to decode the incoming the data and/or the instruction with the key ascertained from the keymap array 110.

With respect to the data flow for the CPU 108, or another hardware block on the SOC 402 to read the data and/or the instruction, following the decoding, the storage control module 102 may return the decoded data and/or the instruction to the CPU 108. Specifically, the decoded data and/or the decoded instruction may be returned to the CPU 108 (or the appropriate hardware block on the SOC 402) via the bus 404.

The data flow for the CPU 108, or another hardware block on the SOC 402 to write data may include similar aspects as the read operation discussed above, with an initiation of a request to memory (e.g., the memristor array 406). The request to memory may flow to the storage control module 102. The storage control module 102 may resolve an address associated with the request to memory, and match the address with the keymap array 110 to ascertain an associated key. If an associated key does not exist (e.g., for new data that is being written to an unused address of the memristor array 406), a key may be generated to encrypt the data. The encryption and decryption module 106 may apply a XOR function to encrypt the data with the key ascertained from the keymap array 110, or with the key otherwise generated to encrypt the data. The storage control module 102 may initiate the request to memory to write the data to the memristor array 406.

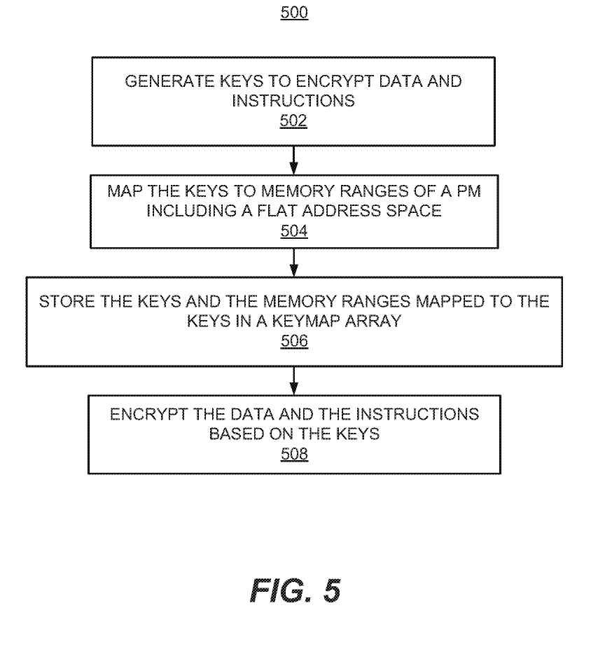

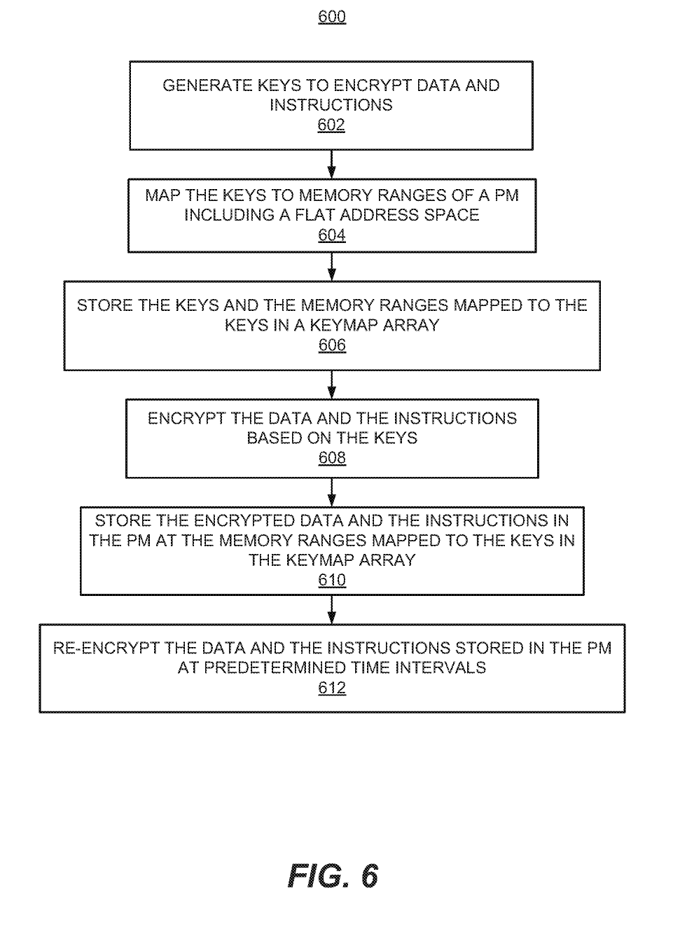

FIGS. 5 and 6 respectively illustrate flowcharts of methods 500 and 600 for data and instruction set encryption, corresponding to the example of the data and instruction set encryption apparatus 100 whose construction is described in detail above. The methods 500 and 600 may be implemented on the data and instruction set encryption apparatus 100 with reference to FIGS. 1-4 by way of example and not limitation. The methods 500 and 600 may be practiced in other apparatus.

Referring to FIG. 5, for the method 500, at block 502, the method may include generating keys to encrypt data and instructions, where the instructions may be executable by a CPU. For example, referring to FIG. 1, the encryption and decryption module 106 may generate keys to encrypt data and instructions.

At block 504, the method may include mapping the keys to memory ranges of a PM including a flat address space. The flat address space of the PM may be partitioned according to the memory ranges. For example, referring to FIG. 1, the keymap array 110 may map the keys to memory ranges of the PM 104 including a flat address space that is partitioned according to the memory ranges. For example, as shown in FIG. 2, each memory range (e.g., 0x00000000 to 0x000FFFFF, etc., corresponding to memory pages) may be assigned to a respective partition of the PM address space. Referring to FIG. 2, the memory ranges of the PM 104 may correspond to memory pages that are mapped to the keys.

At block 506, the method may include storing the keys and the memory ranges mapped to the keys in a keymap array. For example, referring to FIG. 1, the keymap array 110 may store the keys and the memory ranges mapped to the keys.

At block 508, the method may include encrypting the data and the instructions based on the keys. For example, referring to FIG. 1, the encryption and decryption module 106 may encrypt the data and the instructions based on the keys. For example, as shown in FIG. 2, the keys (e.g., 0xFAC18001, etc.) may be used by the encryption and decryption module 106 to encrypt the data and the instructions.

According to an example, the method may include storing the encrypted data and the instructions in the PM at the memory ranges mapped to the keys in the keymap array. For example, referring to FIG. 1, the encrypted data and the instructions may be stored in the PM 104 at the memory ranges mapped to the keys in the keymap array.

According to an example, the method may include decrypting the encrypted data and the instructions based on the keys, and retrieving the decrypted data and the instructions from the memory ranges of the PM that are mapped to the keys in the keymap array. For example, referring to FIG. 1, the encryption and decryption module 106 may decrypt the encrypted data and the instructions based on the keys. Further, the storage control module 102 may retrieve the decrypted data and the instructions from the memory ranges of the PM 104 that are mapped to the keys in the keymap array 110.

According to an example, the method may include re-encrypting the data and the instructions stored in the PM at predetermined time intervals, and/or during idle cycles associated with the CPU. For example, referring to FIG. 1, the storage control module 102 may re-encrypt the data and the instructions stored in the PM 104 at predetermined time intervals, and/or during idle cycles associated with the CPU 108.

According to an example, the method may include determining if the keymap array includes an unmapped memory range. In response to a determination that the keymap array includes the unmapped memory range, the method may include leaving the unmapped memory range as unmapped. Alternatively, the method may include generating a key to encrypt the data and the instructions for the unmapped memory range, and encrypting the data and the instructions based on the key for a first access to the data or the instructions related to the unmapped memory range. For example, referring to FIG. 1, the storage control module 102 may determine if the keymap array 110 includes an unmapped memory range. In response to a determination that the keymap array 110 includes the unmapped memory range, the storage control module 102 may leave the unmapped memory range as unmapped. Alternatively, the storage control module 102 may generate (e.g., by using the encryption and decryption module 106) a key to encrypt the data and the instructions for the unmapped memory range, and encrypt the data and the instructions based on the key for a first access to the data or the instructions related to the unmapped memory range.

Referring to FIG. 6, for the method 600, at block 602, the method may include generating keys to encrypt data and instructions, where the instructions may be executable by a CPU.

At block 604, the method may include mapping the keys to memory ranges of a PM including a flat address space. The flat address space of the PM may be partitioned according to the memory ranges. The memory ranges of the PM may correspond to memory pages that are mapped to the keys.

At block 606, the method may include storing the keys and the memory ranges mapped to the keys in a keymap array.

At block 608, the method may include encrypting the data and the instructions based on the keys.

At block 610, the method may include storing the encrypted data and the instructions in the PM at the memory ranges mapped to the keys in the keymap array.

At block 612, the method may include re-encrypting the data and the instructions stored in the PM at predetermined time intervals. For example, referring to FIG. 1, the storage control module 102 may re-encrypt the data and the instructions stored in the PM at predetermined time intervals.

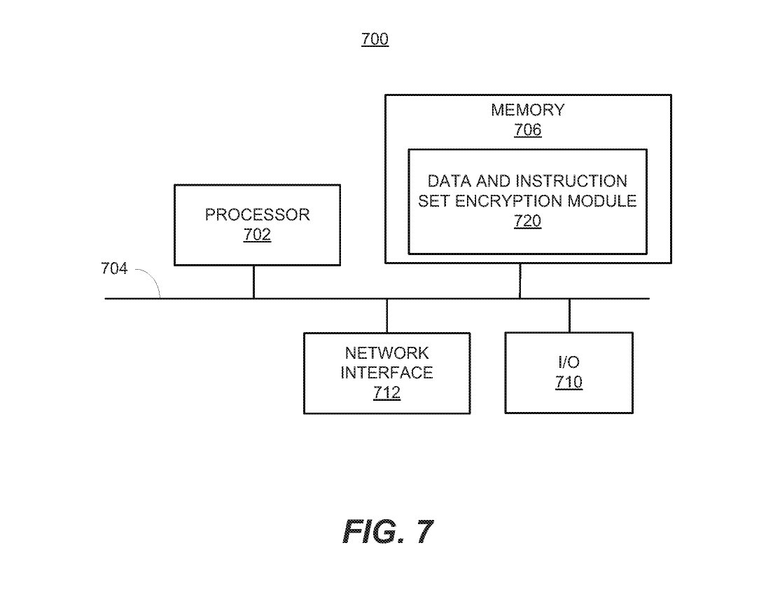

FIG. 7 shows a computer system 700 that may be used with the examples described herein. The computer system 700 may represent a generic platform that includes components that may be in a server or another computer system. The computer system 700 may be used as a platform for the apparatus 100. The computer system 700 may execute, by a processor (e.g., a single or multiple processors) or other hardware processing circuit, the methods, functions and other processes described herein. These methods, functions and other processes may be embodied as machine readable instructions stored on a computer readable medium, which may be non-transitory, such as hardware storage devices (e.g., RAM (random access memory), ROM (read only memory), EPROM (erasable, programmable ROM), EEPROM (electrically erasable, programmable ROM), hard drives, and flash memory).

The computer system 700 may include a processor 702 that may implement or execute machine readable instructions performing some or all of the methods, functions and other processes described herein. Commands and data from the processor 702 may be communicated over a communication bus 704. The computer system may also include a main memory 706 (e.g., the PM 104), such as a random access memory (RAM), where the machine readable instructions and data for the processor 702 may reside during runtime. The memory and data storage are examples of computer readable mediums. The memory 706 may include a data and instruction set encryption module 720 including machine readable instructions residing in the memory 706 during runtime and executed by the processor 702. The data and instruction set encryption module 720 may include the modules of the apparatus 100 shown in FIG. 1.

The computer system 700 may include an I/O device 710, such as a keyboard, a mouse, a display, etc. The computer system may include a network interface 712 for connecting to a network. Other known electronic components may be added or substituted in the computer system.

What has been described and illustrated herein is an example along with some of its variations. The terms, descriptions and figures used herein are set forth by way of illustration only and are not meant as limitations. Many variations are possible within the spirit and scope of the subject matter, which is intended to be defined by the following claims—and their equivalents—in which all terms are meant in their broadest reasonable sense unless otherwise indicated.

What is claimed is:

1. A method for data and instruction set encryption, the method comprising:
generating, by a processor, keys to encrypt data and instructions, wherein the instructions are executable by a central processing unit (CPU);
mapping the keys to memory ranges of a persistent memory (PM) including a flat address space, wherein the flat address space of the PM is partitioned according to the memory ranges;
storing the keys and the memory ranges mapped to the keys in a keymap array; and
encrypting the data and the instructions based on the keys.

2. The method of claim 1, wherein the PM is a memristor array including the flat address space.

3. The method of claim 2, wherein generating keys to encrypt data and instructions further comprises:
generating the keys based on a pseudo-random process based on at least one of time, phase lock loop (PLL) frequency generation, and a resistance value associated with a memristor cell of the memristor array.

4. The method of claim 1, wherein the PM is a phase change memory (PCM) including the flat address space.

5. The method of claim 1, wherein the data and the instructions include at least one of dynamically linked libraries (DLLs), statically linked libraries (SLLs), and executable code.

6. The method of claim 1, wherein the memory ranges of the PM correspond to memory pages that are mapped to the keys.

7. The method of claim 1, further comprising:
storing the encrypted data and the instructions in the PM at the memory ranges mapped to the keys in the keymap array.

8. The method of claim 7, further comprising:
decrypting the encrypted data and the instructions based on the keys; and
retrieving the decrypted data and the instructions from the memory ranges of the PM that are mapped to the keys in the keymap array.

9. The method of claim 7, further comprising:
re-encrypting the data and the instructions stored in the PM at predetermined time intervals.

10. The method of claim 7, further comprising:
re-encrypting the data and the instructions stored in the PM during idle cycles associated with the CPU.

11. The method of claim 1, further comprising:
determining if the keymap array includes an unmapped memory range; and
in response to a determination that the keymap array includes the unmapped memory range, one of:
leaving the unmapped memory range as unmapped; and
generating a key to encrypt the data and the instructions for the unmapped memory range, and encrypting the data and the instructions based on the key for a first access to the data or the instructions related to the unmapped memory range.

12. A data and instruction set encryption apparatus comprising:
an encryption and decryption module, executed by a processor, to generate keys to encrypt data and instructions, wherein the instructions are executable by a central processing unit (CPU);
a keymap array to map the keys to memory ranges of a memristor array including a flat address space, and to store the keys and the memory ranges mapped to the keys, wherein the flat address space of the memristor array is partitioned according to the memory ranges; and
a storage control module to control storage of the data and the instructions in the memristor array at the memory ranges mapped to the keys in the keymap array.

13. The data and instruction set encryption apparatus according to claim 12, wherein the data and instruction set encryption apparatus is implemented on a system on a chip (SOC).

14. The data and instruction set encryption apparatus according to claim 12, wherein the encryption and decryption module is to encrypt the data and the instructions based on the keys.

15. A non-transitory computer readable medium having stored thereon machine readable instructions to provide data and instruction set encryption, the machine readable instructions, when executed, cause a processor to:
generate keys to encrypt data and instructions, wherein the instructions are executable by a central processing unit (CPU);
map the keys to memory ranges of a persistent memory (PM) including a flat address space, wherein the flat address space of the PM is partitioned according to the memory ranges;
store the keys and the memory ranges mapped to the keys in a keymap array;
encrypt the data and the instructions based on the keys;
store the encrypted data and the instructions in the PM at the memo ranges mapped to the keys in the keymap array; and
re-encrypt the data and the instructions stored in the PM at predetermined time intervals.
